(19) United States
(12) Patent Application Publication
(10) Pub. No.: US 2011/0051790 A1
(43) Pub. Date: Mar. 3, 2011

(54) RADIO COMMUNICATION DEVICE AND METHOD

(75) Inventor: Atsushi HONDA, Kawasaki (JP)

(73) Assignee: FUJITSU LIMITED, Kawasaki-shi (JP)

(21) Appl. No.: 12/874,164

(22) Filed: Sep. 1, 2010

(30) Foreign Application Priority Data
Sep. 2, 2009 (JP) 2009-202698

(51) Int. Cl. H04B 1/10; H04B 17/00

(52) U.S. Cl. 375/224; 455/296; 375/350

(57) ABSTRACT

A radio communication device includes a first filter configured to receive a first transmission signal, a second filter configured to receive a second transmission signal orthogonal to the first transmission signal, a radio unit configured to perform quadrature modulation on signals output from the first filter and the second filter, and produce a radio signal, a switch configured to provide, when a first test signal and a second test signal are present, the radio signal to a reception unit as a corresponding test radio signal, and a baseband signal processing unit configured to compensate for in-phase/quadrature imbalance by outputting the first test signal to the first filter, output the second test signal to the second filter, and calculate, on a basis of the test radio signal received via the reception unit, a correction factor to be applied to the first transmission signal and the second transmission signal.

### CROSS-REFERENCE TO RELATED APPLICATION(S)

This application is based upon and claims the benefit of priority of the prior Japanese Patent Application No. 2009-202698, filed on Sep. 2, 2009, the entire contents of which are incorporated herein by reference.

### FIELD

Embodiments of the invention relate to a radio communication device and method.

### BACKGROUND

To reduce the size and cost of radio communication devices, devices employing a direct conversion system have been increasing in recent years. According to the direct conversion system, a transmitter directly up-converts I- and Q-channel baseband signals into a transmission carrier frequency, and a receiver directly down-converts a received signal into I- and Q-channel baseband signals.

The direct conversion system does not require an intermediate filter and image rejection in an IF (Intermediate Frequency), and is expected to result in a reduction in size and cost. However, DC (Direct Current) offset, frequency offset, phase noise, IQ imbalance, and so forth occur as phenomena in an RF (Radio Frequency) unit of a radio communication device. These phenomena deteriorate communication characteristics.

A variety of methods have been studied to compensate for these imperfections of the radio unit (RF unit). A major one of the methods performs channel estimation with the use of a preamble (training signal) included in a received signal, to thereby correct the IQ imbalance, the frequency offset, and the DC offset. If the difference in amplitude and phase between the I and Q channels varies by frequency, however, the variation manifests as the deterioration of the flatness of the signal band. Further, if the variation is substantial, it is difficult to perform the compensation based on the channel estimation.

In view of the above, there is a method for compensating for the IQ imbalance, which provides beforehand a correction factor to a transmission signal to compensate for the IQ imbalance. For example, a method has been known which compensates for the gain imbalance and the phase shift occurring in baseband filters provided for the I- and Q-channels in a transmitter (Japanese Laid-open Patent Publication No. 2006-523057, for example).

### SUMMARY

According to an aspect of the invention, a radio communication device includes a first filter configured to receive an input of a first transmission signal, a second filter configured to receive an input of a second transmission signal orthogonal to the first transmission signal, a radio unit configured to perform quadrature modulation on signals output from the first filter and the second filter, and produce a radio signal, a switch configured to provide, when a first test signal and a second test signal are present, the radio signal to a reception unit as a corresponding test radio signal, and a baseband signal processing unit configured to compensate for in-phase/quadrature imbalance by outputting the first test signal to the first filter, output the second test signal to the second filter, and calculate, on a basis of the test radio signal received via the reception unit, a correction factor to be applied to the first transmission signal and the second transmission signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram of an exemplary radio communication device according to a first embodiment;

FIG. 2 is a block diagram of an exemplary radio communication device according to a second embodiment;

FIG. 3 is a diagram illustrating quadrature modulation by an IQ modulation unit;

FIG. 4 is a diagram illustrating a spectrum obtained when test signals are normally quadrature-modulated;

FIG. 5 is a diagram illustrating a spectrum obtained when test signals are not normally quadrature-modulated;

FIGS. 6A to 6D are diagrams illustrating spectra of respective sections of the radio communication device illustrated in FIG. 2;

FIG. 7 is a diagram illustrating a data configuration example of a correction factor table;

FIG. 8 is a block diagram of an exemplary transmission signal generation unit in FIG. 2;

FIG. 9 is a block diagram of an exemplary radio communication device according to a third embodiment; and

FIG. 10 is a block diagram of an exemplary radio communication device according to a fourth embodiment.

### DESCRIPTION OF THE EMBODIMENTS

The existing method of compensating for the IQ imbalance, however, compensates for the IQ imbalance of the baseband filter. Therefore, the method has an issue of lack of compensation for the IQ imbalance of the radio unit at a subsequent stage of the baseband filter.

The present case has been made in view of the above-described circumstances, and it is an object of the invention to provide a radio communication device capable of compensating for the IQ imbalance of the filter and the radio unit.

To solve the above-described issue, a radio communication device and method which performs radio communication is provided. The radio communication device includes a first filter, a second filter, a radio unit, a switch, and a baseband signal processing unit. The first filter is configured to receive an input of a first transmission signal. The second filter is configured to receive an input of a second transmission signal orthogonal to the first transmission signal. The radio unit is configured to perform quadrature modulation on the signals output from the first filter and the second filter, and output a radio signal. The switch is configured to switch, when a first test signal and a second test signal are present, a test radio signal (output from the radio unit) to a reception unit which receives a radio received signal. The baseband signal processing unit is configured to output the first test signal to the first filter, output the second test signal to the second filter, and calculate, on the basis of the test radio signal output from the reception unit, a correction factor to be applied to the first transmission signal and the second transmission signal to compensate for IQ imbalance occurring in the first filter, the second filter, and the radio unit.

The disclosed radio communication device is capable of compensating for the IQ imbalance of a filter and a radio unit.

A first embodiment will be described in detail with reference to the drawings.

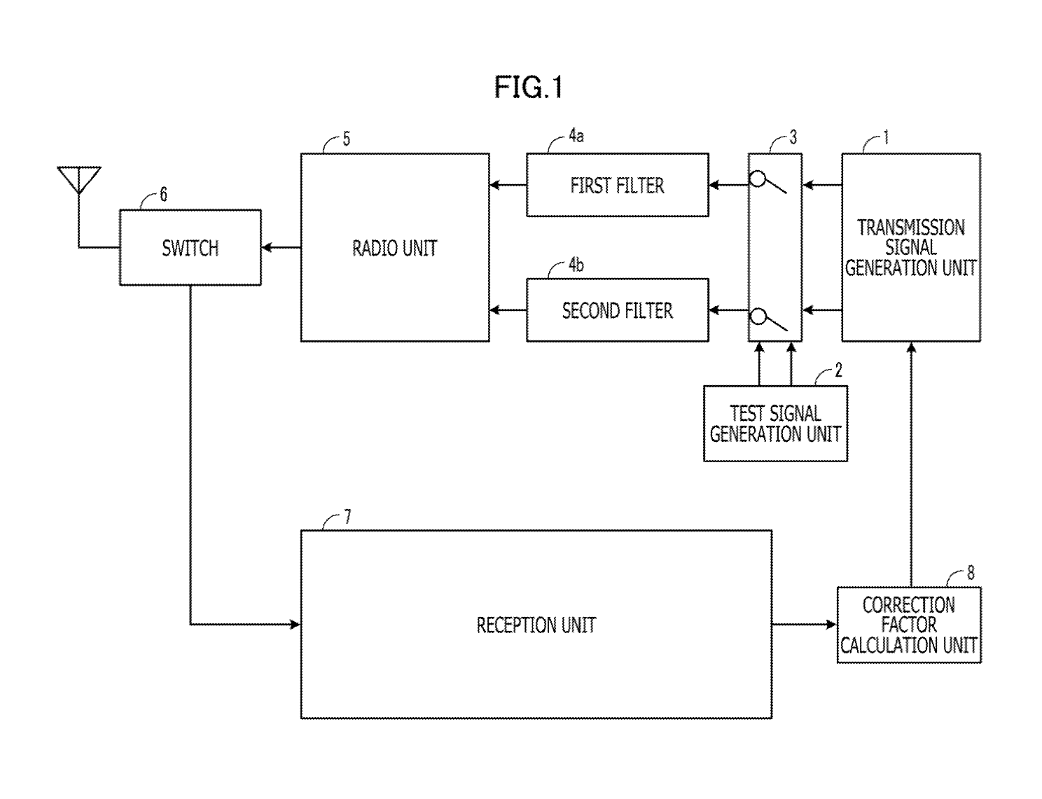

FIG. 1 is a block diagram of a radio communication device according to the first embodiment. As illustrated in FIG. 1, the radio communication device includes a transmission signal generation unit 1, a test signal generation unit 2, switches 3 and 6, a first filter 4a, a second filter 4b, a radio unit 5, a reception unit 7, and a correction factor calculation unit 8.

The transmission signal generation unit 1 generates a first transmission signal and a second transmission signal, orthogonal to the first transmission signal, which are to be transmitted to another communication party. The transmission signal generation unit 1 applies a correction factor calculated by the correction factor calculation unit 8 to the first transmission signal and the second transmission signal, and outputs resultant signals to the switch 3.

The test signal generation unit 2 generates a first test signal and a second test signal. The switch 3 outputs one of the first transmission signal and the first test signal to the first filter 4a, and outputs one of the second transmission signal and the second test signal to the second filter 4b.

The first filter 4a receives an input of the first transmission signal or the first test signal. The second filter 4b receives an input of the second transmission signal or the second test signal. Each of the first filter 4a and the second filter 4b performs band limitation on the signal input thereto, and outputs a resultant signal to the radio unit 5.

The radio unit 5 performs quadrature modulation on the signals output from the first filter 4a and the second filter 4b, and outputs a radio signal.

When the first transmission signal and the second transmission signal are output from the switch 3 and a radio transmission signal is output from the radio unit 5, the switch 6 switches connections such that the radio transmission signal is output to an antenna. Further, when a radio received signal is received from the other communication party, the switch 6 switches connections such that the radio received signal received by the antenna is output to the reception unit 7. Further, when the first test signal and the second test signal are output from the switch 3 and a test radio signal is output from the radio unit 5, the switch 6 switches connections such that the test radio signal is returned to the reception unit 7.

The reception unit 7 performs the processing of receiving an input signal. For example, the reception unit 7 performs down-conversion on an input signal.

On the basis of the test radio signal output from the reception unit 7, the correction factor calculation unit 8 calculates the correction factor for compensating for the IQ imbalance occurring in the first filter 4a, the second filter 4b, and the radio unit 5. As described above, the correction factor is applied to the first transmission signal and the second transmission signal. Thereby, the IQ imbalance of the first filter 4a, the second filter 4b, and the radio unit 5 is compensated.

The radio communication device is thus configured to output the first test signal and the second test signal to the first filter 4a and the second filter 4b, respectively, return the test signals to the reception unit 7 via the radio unit 5, and calculate the correction factor. Accordingly, it is possible to compensate for the IQ imbalance of the first filter 4a, the second filter 4b, and the radio unit 5.

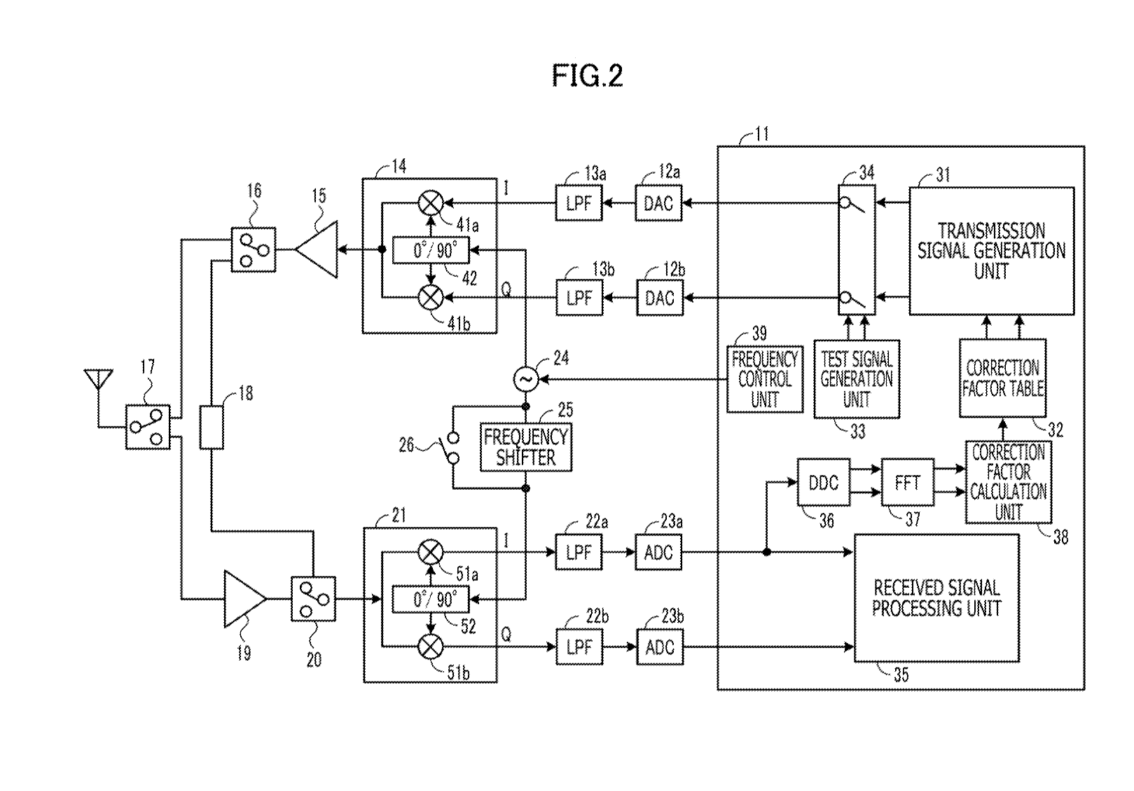

Subsequently, a second embodiment will be described. FIG. 2 is a block diagram of a radio communication device according to the second embodiment. As illustrated in FIG. 2, the radio communication device includes a baseband signal processing unit 11, DACs (Digital to Analog Converters) 12a and 12b, LPFs (Low Pass Filters) 13a, 13b, 22a, and 22b, an IQ modulation unit 14, a PA (Power Amplifier) 15, switches 16, 17, 20, and 26, an ATT (ATTenuater) 18, an LNA (Low Noise Amplifier) 19, an IQ demodulation unit 21, ADCs (Analog to Digital Converters) 23a and 23b, a local oscillator 24, and a frequency shifter 25. The radio communication device is applied to, for example, a mobile phone and a radio base station. The radio communication device performs, for example, radio communication according to the OFDM (Orthogonal Frequency Division Multiplexing) system. Further, the baseband signal processing unit 11 may be realized by a baseband processing LSI (Large Scale Integration).

The radio unit 5 of FIG. 1 may include the IQ modulation unit 14 and the PA (Power Amplifier) 15 of FIG. 2. Further, the reception unit 7 of FIG. 1 may include the LNA (Low Noise Amplifier) 19 and the IQ demodulation unit 21.

The DACs 12a and 12b, the LPFs 13a and 13b, the IQ modulation unit 14, the PA 15, and the switch 16 form a transmission unit. The LNA 19, the switch 20, the IQ demodulation unit 21, the LPFs 22a and 22b, and the ADCs 23a and 23b form a reception unit. The IQ modulation unit 14 and the PA 15 form an RF unit of the transmission unit. The LNA 19 and the IQ demodulation unit 21 form an RF unit of the reception unit. The local oscillator 24 and the frequency shifter 25 form an RF unit shared by the transmission unit and the reception unit.

The baseband signal processing unit 11 generates test signals for calculating a correction factor for compensating for the IQ imbalance of the LPFs 13a and 13b and the RF unit of the transmission unit. In accordance with the switching of the switches 16 and 20, the baseband signal processing unit 11 receives the generated test signals through the device without radio-transmitting the test signals. Then, on the basis of the received test signals, the baseband signal processing unit 11 calculates the correction factor for compensating for the IQ imbalance.

The baseband signal processing unit 11 generates I- and Q-channel digital baseband signals to be transmitted to the other communication party. The baseband signal processing unit 11 applies the above-described correction factor to the generated baseband signals to compensate for the IQ imbalance of the LPFs 13a and 13b and the RF unit of the transmission unit.

The DACs 12a and 12b convert the baseband signals output from the baseband signal processing unit 11 into analog signals. The LPFs 13a and 13b cut off high-frequency components of the baseband signals converted into the analog signals, and allow low-frequency components of the baseband signals to pass therethrough.

The IQ modulation unit 14 performs quadrature modulation on the analog baseband signals output from the LPFs 13a and 13b, and directly up-converts the baseband signals into a radio frequency (RF).

The IQ modulation unit 14 includes multipliers 41a and 41b and a quadrature phase generator (0°/90° in FIG. 2) 42. The quadrature phase generator 42 receives an input of an RF local signal output from the local oscillator 24. The quadrature phase generator 42 sets the phase of the local signal to 0° and 90°, and outputs resultant signals to the multipliers 41a and 41b.

The multiplier 41a multiplies the I-channel baseband signal output from the LPF 13a by the 0° phase local signal, to thereby directly convert the I-channel baseband signal into the RF. The multiplier 41b multiplies the Q-channel baseband signal output from the LPF 13b by the 90° phase local signal, to thereby directly convert the Q-channel baseband signal into the RF. The RF-converted I- and Q-channel baseband signals (radio signals) are synthesized and output to the PA 15.

The PA 15 amplifies the radio signal output from the IQ modulation unit 14. The switch 16 outputs the radio signal output from the PA 15 to one of the switch 17 and the ATT 18. When the baseband signals to be transmitted to the other communication party (transmission signals) are output from the baseband signal processing unit 11, the switch 16 switches outputs such that a radio transmission signal output from the PA 15 is radio-transmitted via an antenna. When the test signals are output from the baseband signal processing unit 11, the switch 16 switches outputs such that the test radio signal output from the PA 15 is received by the baseband signal processing unit 11 via the ATT 18 and the reception unit. The ATT 18 attenuates the test radio signal output from the switch 16.

The switch 17 switches between the connection of the output of the switch 16 with the antenna and the connection of the antenna with the input of the LNA 19. When a transmission signal is radio-transmitted to the other communication party, the switch 17 performs switching such that the output of the switch 16 and the antenna are connected to each other. When a radio received signal is received from the other communication party, the switch 17 performs switching such that the antenna and the input of the LNA 19 are connected to each other.

The LNA 19 amplifies the radio received signal received by the antenna. The switch 20 outputs, to the IQ demodulation unit 21, one of the radio received signal output from the LNA 19 and the test radio signal output from the ATT 18. When the test signals are output from the baseband signal processing unit 11, the switch 20 performs switching such that the test radio signal output from the ATT 18 is output to the IQ demodulation unit 21. When the radio received signal is received from the other communication party, the switch 20 performs switching such that the radio received signal received by the antenna is output to the IQ demodulation unit 21.

When the radio received signal received from the other communication party is output from the switch 20, the IQ demodulation unit 21 performs quadrature demodulation on the radio received signal, and directly down-converts the radio received signal into the frequency of the baseband signals. When the test radio signal is output from the ATT 18, the IQ demodulation unit 21 down-converts the test radio signal into the IF.

The IQ demodulation unit 21 includes multipliers 51a and 51b and a quadrature phase generator 52. The quadrature phase generator 52 receives an input of the RF local signal output from the local oscillator 24. Further, the quadrature phase generator 52 receives an input of a local signal frequency-shifted by the frequency shifter 25 to a lower frequency than the RF (IF-shifted signal). When the radio received signal is received from the other communication party, the quadrature phase generator 52 receives an input of the local signal of the local oscillator 24. When the test signals are output from the baseband signal processing unit 11, the quadrature phase generator 52 receives an input of the IF-shifted signal. The quadrature phase generator 52 sets the respective phases of the local signal and the IF-shifted signal to 0° and 90°, and outputs resultant signals to the multipliers 51a and 51b.

The multiplier 51a multiplies the radio received signal output from the switch 20 by the 0° phase local signal, and outputs an I-channel baseband signal. The multiplier 51b multiplies the radio received signal output from the switch 20 by the 90° phase local signal, and outputs a Q-channel baseband signal. Further, the multiplier 51a multiplies the test radio signal output from the switch 20 by the IF-shifted signal to convert the test radio signal into the IF, and outputs a resultant signal. The test radio signal has the frequency thereof down-converted into the IF, but is not subjected to quadrature demodulation.

The LPFs 22a and 22b cut off high-frequency components of the signals output from the IQ demodulation unit 21, and allow low-frequency components of the signals to pass therethrough. The ADCs 23a and 23b convert the analog signals output from the LPFs 22a and 22b into digital signals, and output the digital signals to the baseband signal processing unit 11.

The local oscillator 24 outputs the RF local signal. The frequency shifter 25 frequency-shifts the RF of the local signal output from the local oscillator 24 to a lower frequency, and outputs the IF-shifted signal. When the test signals are output from the baseband signal processing unit 11, the frequency shifter 25 outputs the IF-shifted signal.

When the transmission signals are output from the baseband signal processing unit 11, the switch 26 switches connections such that a short circuit is caused between the input and output of the frequency shifter 25 to output the local signal of the local oscillator 24 to the IQ demodulation unit 21.

The baseband signal processing unit 11 will be described in detail. The baseband signal processing unit 11 includes a transmission signal generation unit 31, a correction factor table 32, a test signal generation unit 33, a switch 34, a received signal processing unit 35, a DDC (Digital Down Converter) 36, an FFT (Fast Fourier Transform unit) 37, a correction factor calculation unit 38, and a frequency control unit 39.

The transmission signal generation unit 31 places, on the frequency axis, transmission data to be transmitted to the other communication party, performs mapping (subcarrier modulation) of the transmission data onto the QPSK (Quadrature Phase Shift Keying) or 16QAM (Quadrature Amplitude Modulation) constellation, and thereafter performs IFFT (Inverse FFT) processing on the transmission data. Then, the transmission signal generation unit 31 adds guard intervals to the IFFT-processed signals, to thereby generate I- and Q-channel digital baseband signals.

The correction factor table 32 stores the correction factor for compensating for the IQ imbalance of the LPFs 13a and 13b and the RF unit of the transmission unit. The transmission signal generation unit 31 applies the correction factor to the signals subjected to the subcarrier modulation, to thereby compensate for the IQ imbalance of the LPFs 13a and 13b and the RF unit of the transmission unit.

The test signal generation unit 33 generates the test signals for calculating the correction factor for the IQ imbalance. The test signal generation unit 33 generates the digital test signals such that the analog test signals output from the DACs 12a and 12b have sine waves different in phase from each other by 90°.

The switch 34 switches the outputs of the baseband signals output from the transmission signal generation unit 31 and the test signals output from the test signal generation unit 33. When the correction factor is calculated, the switch 34 performs switching such that the test signals output from the test signal generation unit 33 are output to the DACs 12a and 12b. When the transmission signals are transmitted to the other communication party, the switch 34 performs switching such that the baseband signals output from the transmission signal generation unit 31 are output to the DACs 12a and 12b. The calculation of the correction factor is performed, for example, upon power-on of the radio communication device or periodically. The periodical calculation of the correction factor may be performed when the transmission signals are not transmitted to the other communication party.

The received signal processing unit 35 performs, for example, decoding processing of the received signals digitally converted by the ADCs 23a and 23b, to thereby obtain received data transmitted by the other communication party.

The DDC 36 performs digital down-conversion on the IF test radio signal digitally converted by the ADC 23a, to thereby perform digital quadrature demodulation on the test radio signal. The DDC 36 may also perform digital down-conversion on the IF test radio signal digitally converted by the ADC 23b.

The FFT 37 performs Fourier transform on the I- and Q-channel test radio signals subjected to the digital down-conversion by the DDC 36. The correction factor calculation unit 38 calculates the correction factor on the basis of the spectrum of the test radio signals subjected to the Fourier transform, and stores the correction factor in the correction factor table 32. The frequency control unit 39 controls the frequency of the local signal of the local oscillator 24.

The generation of the test signals and the IQ imbalance will be described. To generate the test signals and calculate the correction factor, the switch 16 is first switched to connect the output of the PA 15 to the ATT 18. Further, the switch 20 is switched to connect the ATT 18 to the IQ demodulation unit 21. Thereby, the test signals output from the baseband signal processing unit 11 are returned to the reception unit without being radio-transmitted, and are input to the baseband signal processing unit 11. Further, the switch 26 is brought into the open state such that the local signal of the local oscillator 24 is frequency-shifted by the frequency shifter 25 and output to the IQ demodulation unit 21.

In the OFDM system, if imbalance in amplitude and phase occurs between the I and Q channels, the orthogonality fluctuates, and communication characteristics are deteriorated. In view of this, the test signal generation unit 33 may generate the test signals separately from the transmission signals to be transmitted to the other communication party, and the correction factor calculation unit 38 calculates the correction factor for compensating for the IQ imbalance on the basis of the test radio signals transmitted through the device.

The I- and Q-channel test signals output from the DACs 12a and 12b are represented by the following equations (1) and (2).

X_{testI}(t)=cos ωₗt (1)

X_{testQ}(t)=−sin ωₗt (2)

Herein, the equation ωₗ=2πfₗ holds, wherein fₗ represents the frequency of the test signal, and l represents the subcarrier number. The frequency fₗ is prepared for each subcarrier used for data transmission.

If it is difficult to prepare the test signal for all subcarriers due to, for example, the limitation of the processing time, the test signal may be prepared for some of the subcarriers. In this case, the test signal is prepared to be dispersed across the subcarriers.

The test signals of the above equations (1) and (2) are subjected to quadrature modulation by the IQ modulation unit 14.

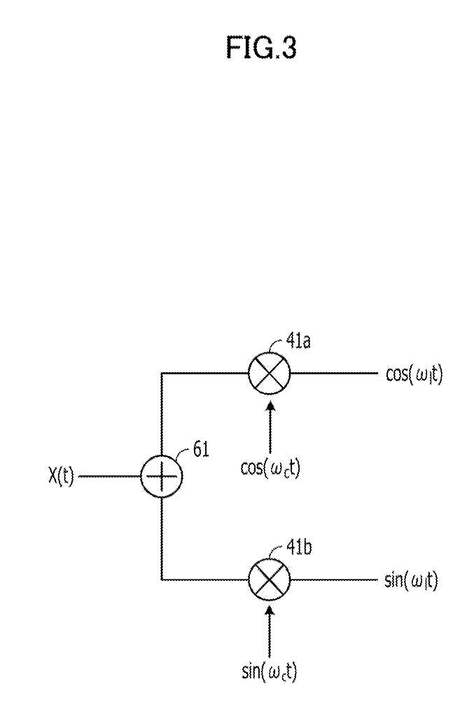

FIG. 3 is a diagram illustrating quadrature modulation by the IQ modulation unit 14. FIG. 3 illustrates the multipliers 41a and 41b of the IQ modulation unit 14 illustrated in FIG. 2. FIG. 3 further illustrates an adder 61 not illustrated in FIG. 2. In FIG. 3, the illustration of the quadrature phase generator 42 is omitted.

The quadrature phase generator 42 (illustrated in FIG. 2) receives an input of the local signal output from the local oscillator 24. The quadrature phase generator 42 outputs the local signals represented by the following equations (3) and (4), which are different in phase from each other by 90°, to the multipliers 41a and 41b, respectively.

L_{I}=cos ω_{c}t (3)

L_{Q}=−sin ω_{c}t (4)

Herein, ω_{c} represents a carrier frequency (RF).

The multiplier 41a multiplies the test signal represented by the equation (1) by the local signal represented by the equation (3). The multiplier 41b multiplies the test signal represented by the equation (2) by the local signal represented by the equation (4). The adder 61 adds up the signals output from the multipliers 41a and 41b, and outputs a signal x(t). Therefore, the signal x(t) output from the IQ modulation unit 14 is represented by the following equation (5).

x(t)=cos(ωₗt)cos(ω_{c}t)−sin(ωₗt)sin(ω_{c}t)=(½)cos(ωₗ+ω_{c})t (5)

According to the equation (5), the frequency of the signal output from the IQ modulation unit 14 is represented as ωₗ+ω_{c}, and the frequency of the test radio signal is shifted from the carrier frequency ω_{c} to a higher frequency by ωₗ.

Further, the equation (5) is resolved and expressed in the following equations (6) and (7).

cos(ωₗt)cos(ω_{c}t)=(½){ cos(ω_{c}+ωₗ)t+cos(ω_{c}−ωₗ)t} (6)

sin(ωₗt)sin(ω_{c}t)=(½){ cos(ω_{c}+ωₗ)t−cos(ω_{c}−ωₗ)t} (7)

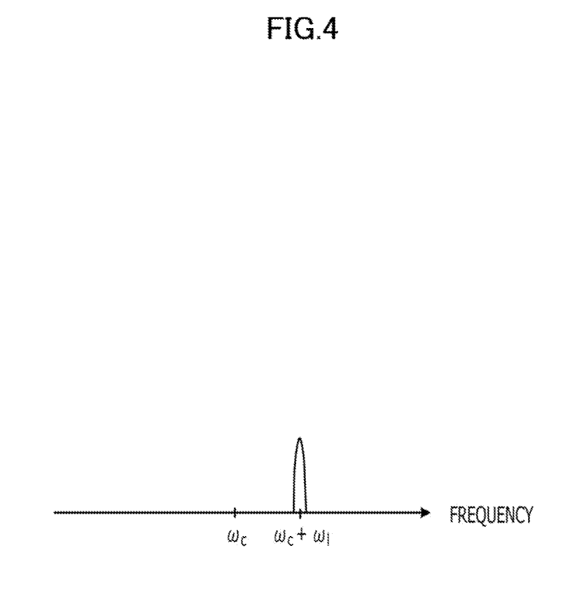

FIG. 4 is a diagram illustrating a spectrum obtained when the test signals are normally quadrature-modulated. According to the equations (6) and (7), if the I- and Q-channel test signals are quadrature-modulated with the 90° phase difference therebetween accurately maintained, the signal shifted from the carrier frequency ω_{c} to a lower frequency by ωₗ is canceled. As illustrated in FIG. 4, therefore, the spectrum of the test radio signal output from the IQ modulation unit 14 remains only in a high-frequency region.

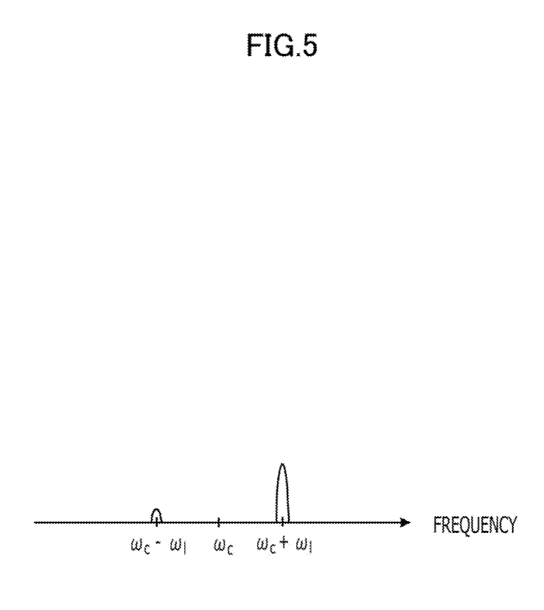

FIG. 5 is a diagram illustrating a spectrum obtained when the test signals are not normally quadrature-modulated. According to the equations (6) and (7), if the I- and Q-channel test signals are not quadrature-modulated with the 90° phase difference therebetween accurately maintained, the signal shifted to a lower frequency is not canceled. As illustrated in FIG. 5, therefore, the spectrum of the test radio signal output from the IQ modulation unit 14 also remains in a low-frequency region. Consequently, the remaining spectrum causes noise and deteriorates communication characteristics.

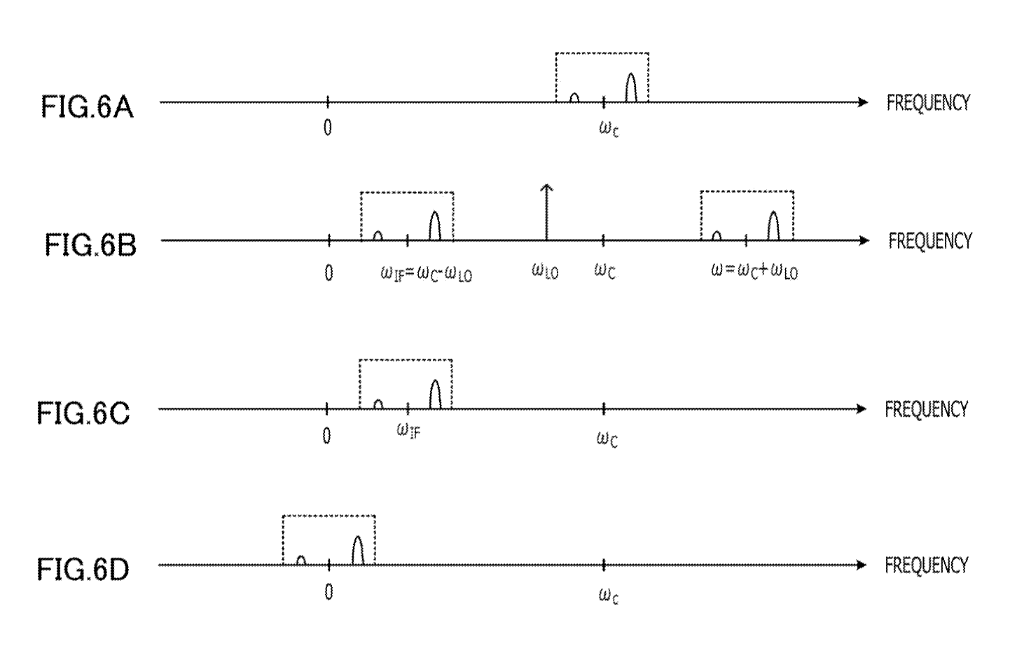

FIGS. 6A to 6D are diagrams illustrating spectra of respective sections of the radio communication device illustrated in FIG. 2. FIG. 6A illustrates the spectrum of the test radio signal in the output from the PA 15 in FIG. 2. FIG. 6B illustrates the spectrum of the test radio signal in the output from the multiplier 51a of the IQ demodulation unit 21. FIG. 6C illustrates the spectrum of the test radio signal in the output from the LPF 22a. FIG. 6D illustrates the spectrum of the test radio signal in the output from the DDC 36.

It is now assumed that the IQ imbalance occurs in the LPF 13a or 13b, the IQ modulation unit 14, or the PA 15. In this case, the spectrum appears in a frequency region lower than the carrier frequency ω_{c} in the output from the PA 15, as illustrated in FIG. 6A.

The test radio signal output from the PA 15 is output to the IQ demodulation unit 21 by the switches 16 and 20. The test radio signal is multiplied by the IF-shifted signal output from the frequency shifter 25 by the multiplier 51a of the IQ demodulation unit 21.

The test radio signal input to the multiplier 51a is down-converted into the IF by the IF-shifted signal, and the test radio signal in the output from the multiplier 51a has a spectrum as illustrated in FIG. 6B. Herein, the frequency of the IF-shifted signal is represented as ω_{L0}(ω_{L0}<ω_{c}). A frequency ω_{IF} of the IF has the relationship represented by the following equation (8).

ω_{IF}=ω_{c}−ω_{L0} (8)

Due to the down-conversion into the IF, the spectrum also appears in a region corresponding to the equation ω=ω_{c}+ω_{L0}.

The LPF 22a cuts off high frequencies of the test radio signal down-converted into the IF and output from the multiplier 51a. As illustrated in FIG. 6C, therefore, the spectrum of the test radio signal in the output from the LPF 22a is cut off in an ω region and remains in an ω_{IF} region.

The test radio signal output from the LPF 22a is digitally converted by the ADC 23a and input to the DDC 36. The DDC 36 multiplies the digital test radio signal output from the ADC 23a by the following equation (9), to thereby perform digital down-conversion on the test radio signal.

y(t)=e^{jω}^{_{IF}}^{t} (9)

With the multiplication using the equation (9), the spectrum of the digitally demodulated test signal is obtained from the DDC 36, as illustrated in FIG. 6D.

The calculation of the correction factor will be described. The test signal digitally demodulated by the DDC 36 is subjected to spectrum calculation by the FFT 37. The correction factor calculation unit 38 retrieves the maximum value of the spectrum calculated by the FFT 37. The correction factor calculation unit 38 calculates the ratio between the spectrum having the retrieved maximum value (the frequency of the transmitted test signal) and a negative spectrum paired with the spectrum having the maximum value, i.e., the DU (Desired to Undesired signal) ratio. That is, the correction factor calculation unit 38 calculates the DU ratio between the upper sideband and the lower sideband illustrated in FIG. 6D.

The test signal generation unit 33 outputs the test signals while changing the amplitude and phase of the I- and Q-channel test signals represented by the equations (1) and (2). The correction factor calculation unit 38 calculates the DU ratio for each of the test signals, the amplitude and phase of which are changed. The correction factor calculation unit 38 stores, in the correction factor table 32, the amplitude ratio of the present amplitude to the initial amplitude value and the phase difference of the present phase from the initial phase value obtained when the DU ratio falls to or below a predetermined threshold value, e.g., 25 dB.

For example, it is now assumed that the test signal generation unit 33 outputs a test signal of Ae^{j}θ, wherein A and θ represent the amplitude and the phase, respectively. The above-described expression of the amplitude-phase representation is denoted by complex notation I+jQ.

The test signal generation unit 33 generates, as the test signal having the initial values, a test signal having values of A=1 and θ=0, for example. The test signal generation unit 33 outputs the test signal while changing the values of A and θ. Herein, it is assumed that the present amplitude and phase obtained when the DU ratio falls to or below a threshold value are represented as A=Aₚ and θ=θₚ, respectively. Then, an amplitude ratio Aₚ/A and a phase difference θₚ are stored in the correction factor table 32. The test signal is generated for all subcarriers or predetermined selected ones of the subcarriers, and the amplitude ratio and the phase difference are calculated while the amplitude and phase of the test signal are changed.

A method of changing the amplitude and phase of the test signal will be described. It is now assumed that the test signal in Subcarrier No. l generated by the test signal generation unit 33 has an amplitude Aₗ and a phase θₗ, wherein l represents the subcarrier number. Herein, there is a method of calculating the DU ratio equal to or less than a predetermined threshold value by retrieving all values of Aₗ (0<Aₗ<a, wherein a represents a positive real number) and θₗ (−π<θₗ<π). In the following, however, description will be made of the steepest descent method of simultaneously retrieving a plurality of parameters.

The steepest descent method changes (updates) the amplitude and phase of the test signal on the basis of the following equation (10).

$$( \begin{matrix}{A}_{l}^{( k + 1 )} \\ {θ}_{l}^{( k + 1 )}\end{matrix} ) = ( \begin{matrix}{A}_{l}^{( k )} \\ {θ}_{l}^{( k )}\end{matrix} ) - α ( \begin{matrix}\partial {D}^{( k )} / \partial {A}_{l}^{( k )} \\ \partial {D}^{( k )} / \partial {θ}_{l}^{( k )}\end{matrix} ) \qquad ( 10 )$$

Herein, α represents the value determining the update rate, and is a positive real number. Further, Aₗ^{(k)} and θₗ^{(k)} represent the respective values of the amplitude and phase obtained by the k times of updates. Further, D^{(k)} represents the DU ratio obtained by the k-th update. For example, values of Aₗ⁽⁰⁾=1 and θₗ⁽⁰⁾=0 are set as the initial values, and the DU ratio is measured while the values of Aₗ and θₗ are changed by minute amounts. Then, the obtained results are substituted in the equation (10) to simultaneously update the amplitude and phase.

The calculation is repeated until the DU ratio falls to or below the preset threshold value. This calculation is performed in all subcarriers used for data communication or predetermined selected ones of the subcarriers. The amplitude ratio and the phase difference obtained for each of the subcarriers are stored in the correction factor table 32.

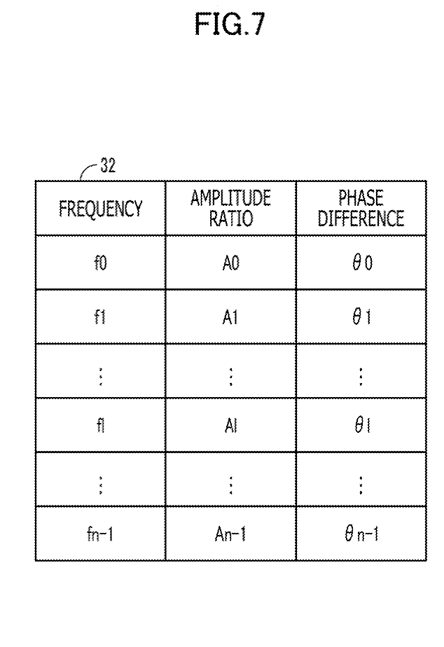

FIG. 7 is a diagram illustrating a data configuration example of the correction factor table 32. As illustrated in FIG. 7, the correction factor table 32 includes frequency, amplitude ratio, and phase difference fields.

The frequency field stores the frequency corresponding to the subcarrier. The respective fields of amplitude ratio and phase difference store the amplitude ratio and the phase difference of the test signal in the frequency of the frequency field, which are obtained when the DU ratio falls to or below the threshold value.

For example, it is understood from the correction factor table 32 that, in the example of FIG. 7, Aₗ and θₗ respectively represent the amplitude ratio and the phase difference of the test signal in a frequency fₗ corresponding to Subcarrier No. l, which are obtained when the DU ratio falls to or below the threshold value.

The compensation for the IQ imbalance will be described in detail.

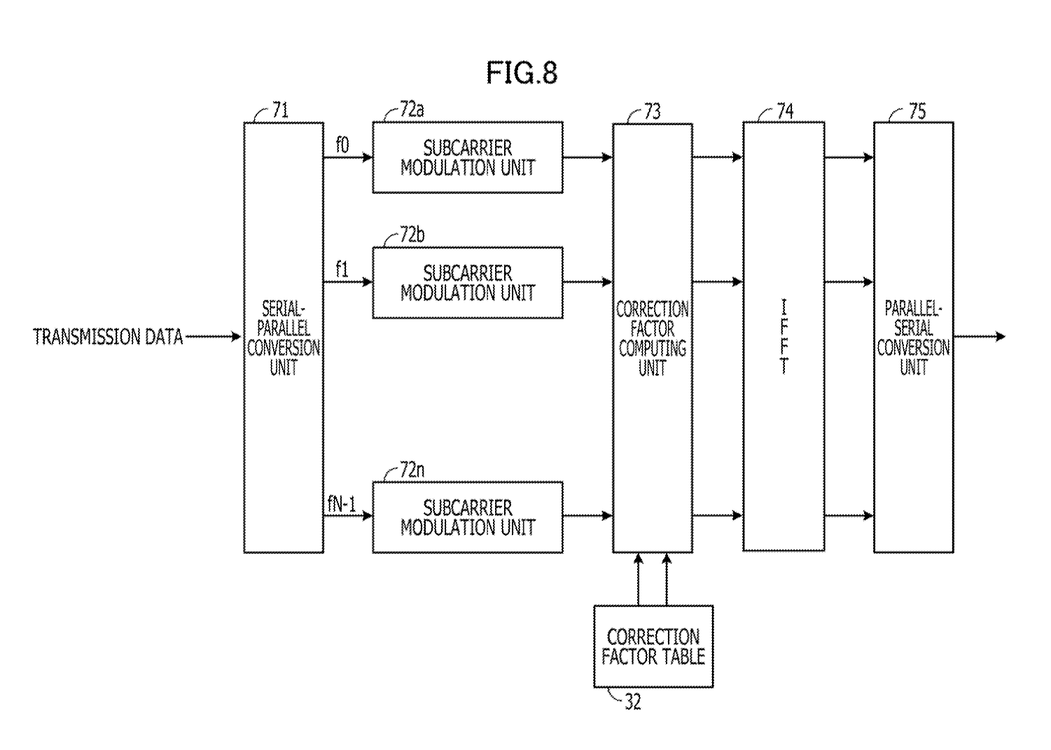

FIG. 8 is a block diagram of the transmission signal generation unit 31 illustrated in FIG. 2. As illustrated in FIG. 8, the transmission signal generation unit 31 includes a serial-parallel conversion unit 71, subcarrier modulation units 72a to 72n, a correction factor computing unit 73, an IFFT 74, and a parallel-serial conversion unit 75. FIG. 8 also illustrates the correction factor table 32.

The serial-parallel conversion unit 71 receives an input of serial transmission data. The serial-parallel conversion unit 71 converts the input serial transmission data into parallel data, and places the data on the frequency axis (subcarriers f₀, f₁, . . . , and f_{N-1}).

The subcarrier modulation units 72a to 72n map the transmission data placed by the serial-parallel conversion unit 71 onto signal points of, for example, the QPSK or 16QAM constellation.

The correction factor computing unit 73 applies the correction factor stored in the correction factor table 32 to the signal subjected to the subcarrier modulation (primary modulation). For example, the correction factor computing unit 73 applies an amplitude ratio A₀ and a phase difference θ₀ of the correction factor table 32 in FIG. 7 to the signal output from the subcarrier modulation unit 72a. Further, the correction factor computing unit 73 applies an amplitude ratio A₁ and a phase difference θ₁ of the correction factor table 32 in FIG. 7 to the signal output from the subcarrier modulation unit 72b.

The IFFT 74 performs an inverse Fourier transform on the signal applied with the correction factor by the correction factor computing unit 73. That is, the IFFT 74 converts the signal in the frequency domain allocated to the subcarrier into a signal sequence in the time domain.

The parallel-serial conversion unit 75 converts the signal sequence in the time domain output in parallel from the IFFT 74 into serial data, and outputs the serial data. In this process, the insertion of guard intervals is performed.

As described above, the transmission data is placed on the frequency axis by the serial-parallel conversion unit 71, and is subjected to the primary modulation by the subcarrier modulation units 72a to 72n in accordance with the QPSK or 16QAM system, for example. The transmission data subjected to the primary modulation is represented by the following equation (11).

dₗ=Rₗe^{jφl} (11)

Herein, l represents the subcarrier number (l=0, 1, . . . , or N-1), and dₗ represents the transmission data subjected to the primary modulation. Further, Rₗ and φₗ represent the amplitude and the phase, respectively. The transmission data dₗ is mapped on a complex plane, and is represented as dₗ=1+j in the QPSK system, for example.

Subjected to IFFT, the above transmission data is converted into a transmission signal on the time axis. The transmission signal is represented by IDFT (Inverse Discrete Fourier Transform), as in the following equation (12).

$$S ( k ) = {\sum }_{l = 0}^{N - 1} {d}_{l} {e}^{j 2 π l \frac{k}{N}} \qquad ( 12 )$$

Herein, N represents the number of points in the IFFT, and k represents the sampling point of the transmission signal on the time axis (k=0, 1, . . . , or N-1).

Herein, the signal subjected to the primary modulation and represented by the equation (11) is multiplied by the amplitude of the correction factor table 32 by the correction factor computing unit 73, and is added with the phase. Therefore, the signal output from the correction factor computing unit 73 is represented as in the equation (13).

\tilde{d}=AₗRₗe^{j(φ}^{ₗ}^{+θ}^{ₗ}⁾ (13)

With this corrected signal subjected to an inverse Fourier transform by the IFFT 74, it is possible to obtain a transmission signal on the time axis for compensating for the IQ imbalance, which is represented by the following equation (14).

$$\tilde{S} ( k ) = {\sum }_{l = 0}^{N - 1} {\tilde{d}}_{l} {e}^{j 2 π l \frac{k}{N}} \qquad ( 14 )$$

The radio communication device is thus configured to output the test signals to the LPFs 13a and 13b, return the test signals to the reception unit via the RF unit of the IQ modulation unit 14 and the PA 15, and calculate the correction factor. Accordingly, it is possible to compensate for the IQ imbalance of the LPFs 13a and 13b and the RF unit.

Further, the test radio signal is down-converted into the IF, and is subjected to quadrature demodulation by the DDC 36. Accordingly, it is possible to calculate an appropriate correction factor without requiring the IQ demodulation unit 21 to achieve highly accurate orthogonality.

Further, with the correction factor calculated upon power-on of the device or periodically, it is possible to handle a change in IQ imbalance caused by a change in temperature.

Further, the test signals are returned within the radio communication device. Therefore, there is no influence of image reception due to space propagation, and the LPFs 22a and 22b do not require a channel selection filter or the like.

In the example of FIG. 2, the correction factor table 32, the test signal generation unit 33, the DDC 36, the FFT 37, and the correction factor calculation unit 38 are included in the baseband signal processing unit 11. However, these components may be provided outside the baseband signal processing unit 11.

Further, the output of the LNA 19 is provided with the switch 20. However, the input of the LNA 19 may be provided with the switch 20.

Subsequently, a third embodiment will be described. In the second embodiment, the IF-shifted signal for down-converting the test radio signal into the IF is generated through the frequency shift of the frequency of the local signal by a frequency shifter. In the third embodiment, the IF-shifted signal is generated by an independent oscillator.

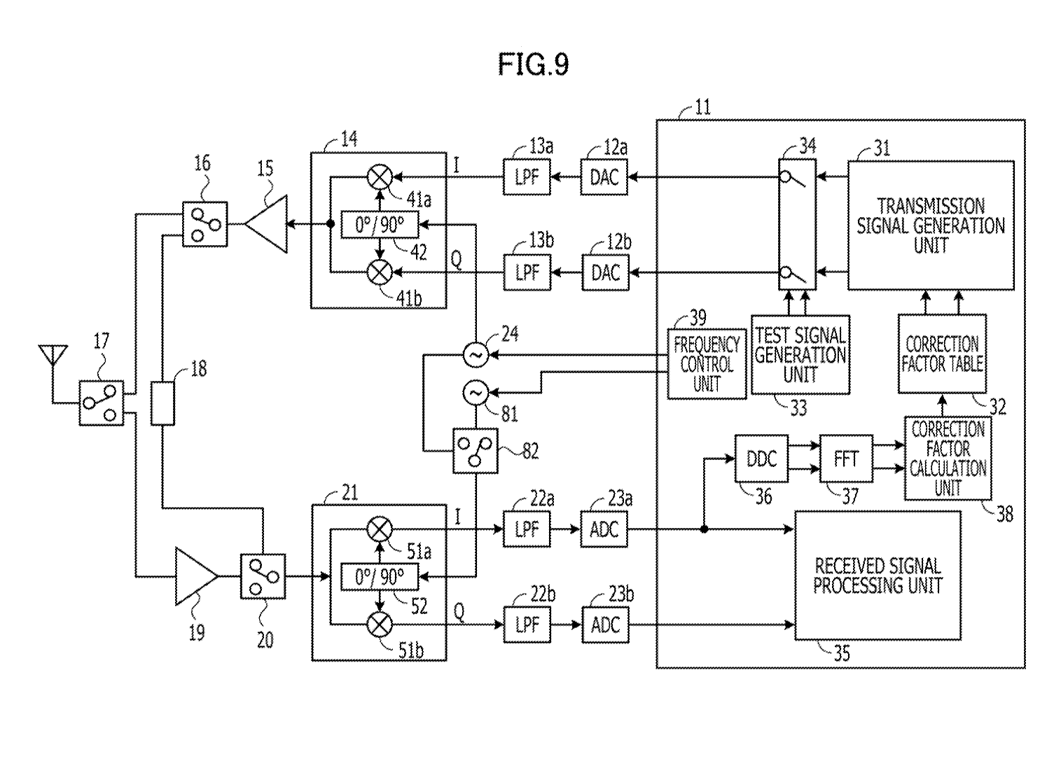

FIG. 9 is a block diagram of a radio communication device according to the third embodiment. In FIG. 9, the same components as those of FIG. 2 are denoted by the same reference numerals, and description thereof will be omitted.

In the radio communication device of FIG. 9, as compared with the radio communication device of FIG. 2, the frequency shifter 25 and the switch 26 are omitted, and an IF oscillator 81 and a switch 82 are provided. The IF oscillator 81 outputs an IF-shifted signal for down-converting, into the IF, the frequency of the test radio signal input to the IQ demodulation unit 21 via the transmission unit, the ATT 18, and the switch 20. The frequency of the IF-shifted signal is represented as ω_{LO}.

When the test signals are output from the baseband signal processing unit 11, the switch 82 performs switching such that the IF-shifted signal output from the IF oscillator 81 is output to the IQ demodulation unit 21. When the transmission signals to be transmitted to the other communication party are output from the baseband signal processing unit 11, the switch 82 performs switching such that the local signal of the local oscillator 24 is output to the IQ demodulation unit 21.

With the IF-shifted signal thus output by the IF oscillator 81, the circuit configuration can be simplified.

Subsequently, a fourth embodiment will be described. In the second and third embodiments, a switch for looping back a test pattern is provided to the output of the PA. In the fourth embodiment, the input of the PA is provided with a switch for looping back the test radio signal.

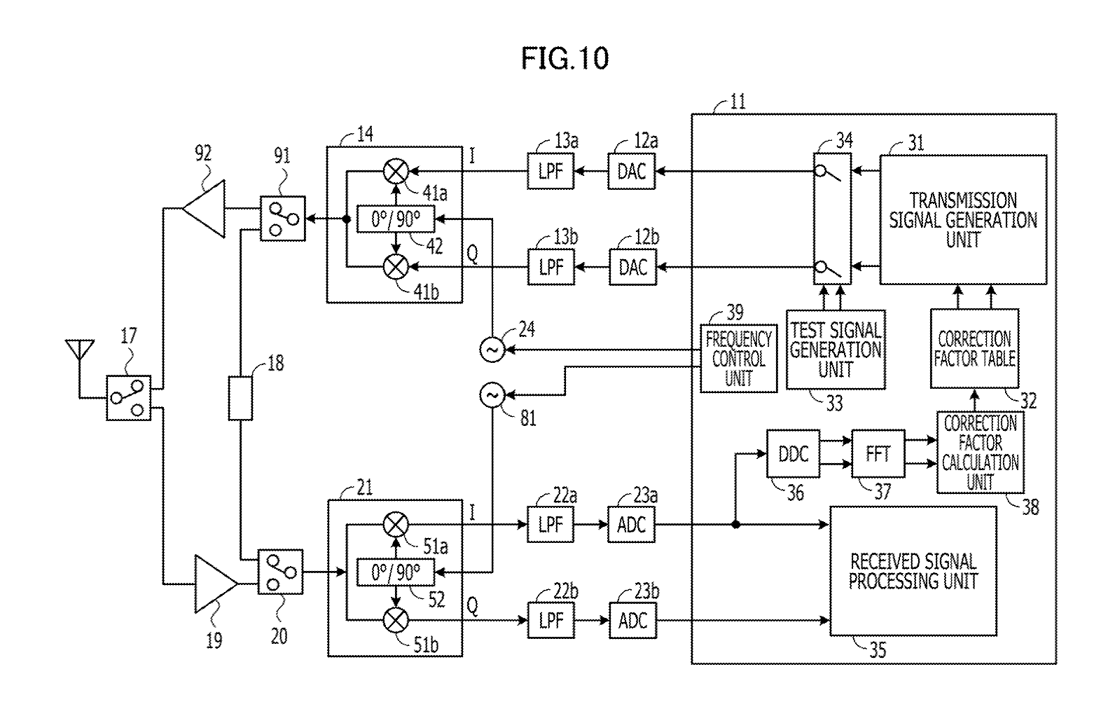

FIG. 10 is a block diagram of a radio communication device according to the fourth embodiment. In FIG. 10, the same components as those of FIG. 9 are denoted by the same reference numerals, and description thereof will be omitted.

In the radio communication device of FIG. 10, as compared with the radio communication device of FIG. 9, the respective positions of a switch 91 and a PA 92 are reversed. That is, the switch 91 is provided between the IQ modulation unit 14 and the PA 92.

With the switch 91 thus provided at a previous stage of the PA 92, it is possible to compensate for the loss of the radio transmission signal in the switch 91 with the gain of the PA 92.

The above-described compensation techniques, respectively, can reduce, if not substantially eliminate, IQ (In-phase/Quadrature) imbalance.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the invention(s) has(have) been described in detail, it should be understood that the various changes, substitutions, and alterations could be made hereto without departing from the spirit and scope of the invention.

What is claimed is:

1. A radio communication device comprising:
a first filter configured to receive an input of a first transmission signal;
a second filter configured to receive an input of a second transmission signal orthogonal to the first transmission signal;
a radio unit configured to perform quadrature modulation on signals output from the first filter and the second filter, and produce a radio signal;
a switch configured to provide, when a first test signal and a second test signal are present, the radio signal to a reception unit as a corresponding test radio signal; and
a baseband signal processing unit configured to compensate for in-phase/quadrature imbalance by outputting the first test signal to the first filter, output the second test signal to the second filter, and calculate, on a basis of the test radio signal received via the reception unit, a correction factor to be applied to the first transmission signal and the second transmission signal.

2. The radio communication device according to claim 1, wherein the reception unit down-converts the test radio signal into an intermediate frequency band, and converts the test radio signal into a digital signal.

3. The radio communication device according to claim 2, further comprising:
a digital down-converter configured to down-convert the test radio signal converted into the digital signal into the frequency of a baseband signal;
a spectrum calculation unit configured to calculate a spectrum of the test radio signal down-converted by the digital down-converter; and
a correction factor calculation unit configured to calculate the correction factor on a basis of the spectrum.

4. The radio communication device according to claim 3, further comprising:
a test signal generation unit configured to output the first test signal and the second test signal while changing the amplitude and phase of the signals,
wherein the correction factor calculation unit retrieves a first spectrum having a maximum value and a second spectrum paired with the first spectrum, and stores, in a correction factor table, an amplitude ratio of the present amplitude to an initial amplitude value and a phase difference of a present phase from an initial phase value obtained when the ratio between the first spectrum and the second spectrum falls to or below a threshold value.

5. The radio communication device according to claim 4, wherein the test signal generation unit outputs the first test signal and the second test signal while changing the frequency of the signals, and
wherein the correction factor calculation unit stores, in the correction factor table, the amplitude ratio and the phase difference for each frequency.

6. The radio communication device according to claim 4, further comprising:
a transmission signal generation unit configured to apply the amplitude ratio and the phase difference stored in the correction factor table to the first transmission signal and the second transmission signal, and output the first and second transmission signals.

7. The radio communication device according to claim 2, further comprising:
a frequency shifter configured to shift, to a lower frequency, the frequency of a local signal used for the quadrature modulation by the radio unit, and output an intermediate shifted signal used for the down-conversion of the test radio signal by the reception unit into the intermediate frequency band.

8. The radio communication device according to claim 2, further comprising:
an oscillator configured to output an intermediate shifted signal used for the down-conversion of the test radio signal by the reception unit into the intermediate frequency band.

9. The radio communication device according to claim 1, wherein the radio unit includes
a quadrature modulation unit configured to perform the quadrature modulation on the signals output from the first filter and the second filter, and
an amplifier configured to amplify the signals subjected to the quadrature modulation by the quadrature modulation unit,
wherein the switch outputs, to the reception unit, the test radio signal output from the amplifier of the radio unit.

10. The radio communication device according to claim 1,
wherein the radio unit includes
a quadrature modulation unit configured to perform the quadrature modulation on the signals output from the first filter and the second filter, and
an amplifier configured to amplify the signals subjected to the quadrature modulation by the quadrature modulation unit,
wherein the switch outputs, to the reception unit, the test radio signal output from the quadrature modulation unit of the radio unit.

11. A method of radio communication comprising:
receiving, at a first filter, an input of a first transmission signal;
receiving, at a second filter, input of a second transmission signal orthogonal to the first transmission signal;
performing quadrature modulation on the signals output from the first filter and the second filter to produce a radio signal;
feeding back the radio signal as a test radio signal when a first test signal and a second test signal are present;
outputting the first test signal to the first filter the second test signal to the second filter; and
calculating, on a basis of the feedback test radio signal, a correction factor to be applied to the first transmission signal and the second transmission signal.

12. The method of radio communication according to claim 11, further comprising down-converting the test radio signal into an intermediate frequency band, and converting the test radio signal into a digital signal.

13. The method of radio communication according to claim 12, further comprising:
down-converting the test radio signal converted into the digital signal into the frequency of a baseband signal;
calculating a spectrum of the test radio signal down-converted; and
calculating the correction factor on a basis of the spectrum.

14. The method of radio communication according to claim 13, further comprising:
outputting the first test signal and the second test signal while changing the amplitude and phase of the signals;
retrieving a first spectrum having a maximum value and a second spectrum paired with the first spectrum; and
storing, in a correction factor table, an amplitude ratio of the present amplitude to an initial amplitude value and a phase difference of a present phase from an initial phase value obtained when the ratio between the first spectrum and the second spectrum falls to or below a threshold value.

15. The method of radio communication according to claim 14, further comprising
outputting the first test signal and the second test signal while changing the frequency of the signals, and
storing, in the correction factor table, the amplitude ratio and the phase difference for each frequency.

16. The method of radio communication according to claim 14, further comprising:
applying the amplitude ratio and the phase difference stored in the correction factor table to the first transmission signal and the second transmission signal, and
outputting the first and second transmission signals.

17. The method of radio communication according to claim 12, further comprising:
shifting, to a lower frequency, the frequency of a local signal used for the quadrature modulation, and
outputting an intermediate shifted signal used for the down-conversion of the test radio signal into the intermediate frequency band.

18. The method of radio communication according to claim 12, further comprising outputting an intermediate shifted signal used for the down-conversion of the test radio signal into the intermediate frequency band.

19. The method of radio communication according to claim 11, further comprising:
performing the quadrature modulation on the signals output from the first filter and the second filter, and
amplifying the signals subjected to the quadrature modulation; and
outputting the test radio signal.

20. The method of radio communication according to claim 11, further comprising:
performing the quadrature modulation on the signals output from the first filter and the second filter;
amplifying the signals subjected to the quadrature modulation; and
outputting the test radio signal.
